(19) United States
(12) Patent Application Publication
(10) Pub. No.: US 2025/0364655 A1
(43) Pub. Date: Nov. 27, 2025

(54) BATTERY CELL MOUNTING APPARATUS, BATTERY PACK INCLUDING THE SAME, AND METHOD OF MANUFACTURING THE BATTERY CELL MOUNTING APPARATUS

(71) Applicant: Samsung SDI Co., Ltd., Yongin-si (KR)

(72) Inventor: SANGHUN PARK, Yongin-si (KR)

(21) Appl. No.: 18/988,572

(22) Filed: Dec. 19, 2024

(30) Foreign Application Priority Data
May 23, 2024 (KR) 10-2024-0067441

(51) Int. Cl. H01M 50/213; H01M 50/503

(52) U.S. Cl. CPC H01M 50/213; H01M 50/503

(57) ABSTRACT

A battery cell mounting apparatus include: a spacer having a shape corresponding to shapes of sides of a plurality of battery cells and configured to support the sides of the plurality of battery cells; and a plurality of electrode tabs configured to electrically connect the plurality of battery cells. One of the electrode tabs is inserted into the spacer and formed integrally with the spacer.

### CROSS-REFERENCE TO RELATED APPLICATION

The present application claims priority to and the benefit of Korean Patent Application No. 10-2024-0067441, filed on May 23, 2024, in the Korean Intellectual Property Office, the entire disclosure of which is incorporated herein by reference.

### BACKGROUND

### 1. Field

Aspects of embodiments of the present disclosure relate to a battery cell mounting apparatus, a battery pack including the same, and a method of manufacturing the battery cell mounting apparatus.

### 2. Description of the Related Art

Different from primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. A secondary battery generally includes an electrode assembly including (or consisting of) a positive electrode and a negative electrode, a case that accommodates the electrode assembly, a terminal part connected to the electrode assembly, etc.

A power system for a battery pack that is constructed by using a secondary battery is formed (or secured) by connecting multiple battery cells, with the number and connection configuration thereof depending on an apparatus to which the battery pack is applied. The battery pack may be constructed by inserting a spacer between battery cells, inserting an electrode tab into both ends of the battery cell, and then welding them. Various types of spacers and electrode tabs for constructing a battery pack are used on the market. However, a material cost increases and a process becomes more complicated because different spacer and electrode tab structures are used based on each apparatus to which the battery pack is applied.

The above information disclosed in this Background section is for enhancement of understanding of the background of the present disclosure, and therefore, it may contain information that does not constitute related (or prior) art.

### SUMMARY

Embodiments of the present disclosure provide a battery cell mounting apparatus in which a spacer and an electrode tab have been integrally formed, a battery pack including the same, and a method of manufacturing the battery cell mounting apparatus.

However, aspects and features of the present disclosure are not limited to those described above, and other aspects and features not mentioned herein will be clearly understood by those skilled in the art from the description of the present disclosure below.

A battery cell mounting apparatus, according to an embodiment of the present disclosure, includes: a spacer having a shape corresponding to shapes of the sides of a plurality of battery cells and configured to support the sides of the plurality of battery cells; and a plurality of electrode tabs configured to electrically connect the plurality of battery cells. One of the electrode tabs is inserted into the spacer and formed integrally with the spacer.

In some embodiments, the spacer may be formed by insert-injecting the electrode tab to be inserted into the spacer.

In some embodiments, the electrode tab may include fixing legs that downwardly extend to fix the electrode tab when the spacer is injected.

In some embodiments, the electrode tab may have a fixing opening for fixing the electrode tab when the spacer is injected.

In some embodiments, the electrode tab may include a protrusion that is inserted into the spacer and that protrudes in a direction toward the inside of the spacer.

In some embodiments, the protrusion may have a through hole.

In some embodiments, a welding opening for welding with the battery cell may be at the end of the electrode tab.

In some embodiments, the spacer may have a length longer than the length of the battery cell so that the spacer protrudes beyond the battery cell when the battery cell is coupled to the spacer.

A battery pack, according to an embodiment of the present disclosure, includes: a plurality of battery cells; a spacer having a shape corresponding to shapes of the sides of the battery cells that are mounted on the spacer and supporting the sides of the plurality of battery cells; and a plurality of electrode tabs configured to electrically connect the battery cells. One of the electrode tabs may be inserted into the spacer and formed integrally with the spacer.

In some embodiments, the spacer may be formed by insert-injecting the electrode tab to be inserted into the spacer.

In some embodiments, the electrode tab may include fixing legs that downwardly extend to fix the electrode tab when the spacer is injected.

In some embodiments, the electrode tab may have a fixing hole for fixing the electrode tab when the spacer is injected.

In some embodiments, the electrode tab may include a protrusion that is inserted into the spacer and that protrudes in a direction toward the inside of the spacer.

In some embodiments, the protrusion may have a through hole.

In some embodiments, a welding opening for welding with the battery cell may be at the end of the electrode tab.

In some embodiments, the spacer may have a length longer than the length of the battery cell so that the spacer protrudes beyond the battery cell when the battery cell is coupled to the spacer.

A method of manufacturing a battery cell mounting apparatus, according to an embodiment of the present disclosure, includes: manufacturing a plurality of electrode tabs for electrically connecting a plurality of battery cells; and integrally forming a spacer having a shape corresponding to shapes of sides of the battery cells and supporting the sides of the battery cells by inserting one or more of the electrode tabs into the spacer.

In some embodiments, the integrally forming of the spacer may include forming the spacer by insert-injecting the electrode tab to be inserted into the spacer.

In some embodiments, the forming of the spacer by insert-injecting the electrode tab may include fixing the electrode tab by using a downwardly extending fixing leg of the electrode tab and injecting the spacer into the fixed electrode tab.

In some embodiments, the method may further include removing the fixing leg after the spacer is injected.

According to embodiments of the present disclosure, in constructing the battery pack constructed by connecting a plurality of battery cells in series and/or in parallel, costs can be reduced by standardizing materials and simplifying a process through a standardized structure.

According to embodiments of the present disclosure, coupling strength when a battery cell is mounted on the electrode tab can be increased because a coupling force between the spacer and the electrode tab is increased by integrating the spacer and the electrode tab.

According to embodiments of the present disclosure, the volume of the battery pack can be reduced by maximizing an integrated portion of the spacer and the electrode tab.

According to embodiments of the present disclosure, the spacer is integrally formed with the electrode tab through insert-injection in the state in which the electrode tab is fixed. Accordingly, an accurate location of the electrode tab can be secured when the battery cell is mounted on the electrode tab because the electrode tab is disposed at a fixed location relative to the spacer.

However, aspects and features of the present disclosure are not limited to those described above, and other aspects and features not mentioned herein will be clearly understood by a person skilled in the art from the detailed description, described below.

### BRIEF DESCRIPTION OF THE DRAWINGS

The following drawings attached to this specification illustrate embodiments of the present disclosure and provide a further understand the technical spirit of the present disclosure along with the aforementioned content of the disclosure. Accordingly, the present disclosure should not be construed as being limited to only the embodiments and configurations described in such drawings.

FIG. 1A is an upper perspective view of a cylindrical secondary battery.

FIG. 1B is a cross-sectional view the cylindrical secondary battery shown in FIG. 1A.

FIGS. 2A to 2C illustrate a battery pack that is constructed by mounting a battery cell mounting apparatus, according to embodiments of the present disclosure, on a battery cell.

FIGS. 3A to 3C illustrate an electrode tab of the battery cell mounting apparatus according to embodiments of the present disclosure.

FIGS. 4A to 4E illustrates steps of a method of manufacturing the battery cell mounting apparatus according to embodiments of the present disclosure.

FIGS. 5A to 5C illustrate a battery cell mounting apparatus according to embodiments of the present disclosure in which the battery cells are connected in a 2s1p (2 serial 1 parallel) configuration.

FIGS. 6A to 6C illustrate a battery cell mounting apparatus according to embodiments of the present disclosure in which the battery cells are connected in a 1s2p (1 serial 2 parallel) configuration.

FIGS. 7A to 7C illustrate a battery cell mounting apparatus according to embodiments of the present disclosure in which the battery cells are connected in a 4s1p (4 serial 1 parallel) configuration.

FIGS. 8A to 8C are illustrate a battery cell mounting apparatus according to embodiments of the present disclosure in which the battery cells are connected in a 2s2p (2 serial 2 parallel) configuration.

### DETAILED DESCRIPTION

Exemplary embodiments of the present disclosure will be described below in detail with reference to the accompanying drawings. The terms or words used in this specification and claims should not be construed as being limited to common or dictionary meanings but instead should be understood to have meanings and concepts in agreement with the spirit of the present disclosure based on the principle that an inventor can define the concept of each term suitably to describe his/her own invention in the best way possible. Accordingly, because the embodiments described in this specification and the configurations illustrated in the drawings are only examples of the present disclosure and do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

To facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of about 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

Examples of secondary batteries include a coin type, a cylindrical type, a prismatic type, and a pouch type. The present disclosure is also applicable to a prismatic secondary battery. Therefore, the cylindrical secondary battery will first be briefly described prior to description of embodiments of the present disclosure.

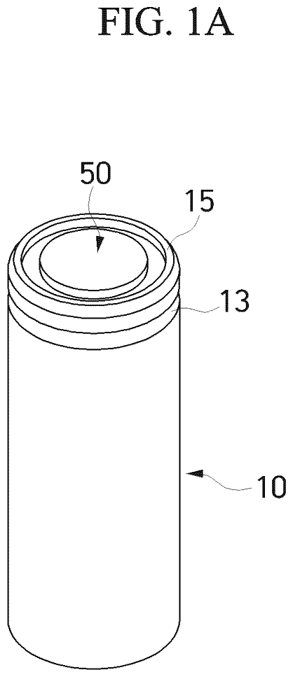

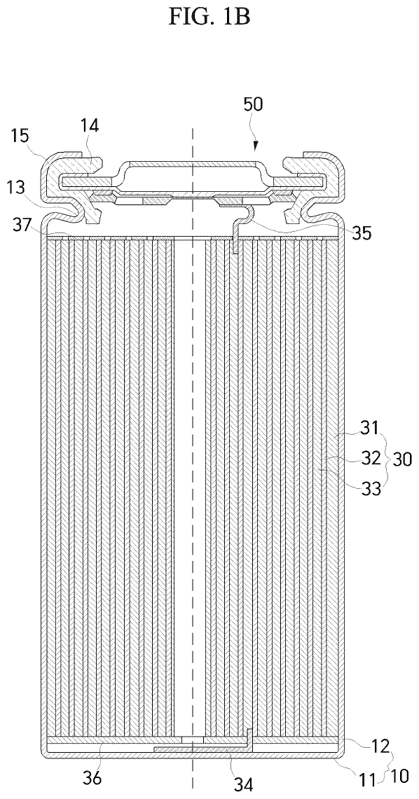

FIG. 1A is an upper perspective view of a cylindrical secondary battery, and FIG. 1B is a cross-sectional view the cylindrical secondary battery.

Referring to FIGS. 1A and 1B, the cylindrical secondary battery may include an electrode assembly 30, a case 10 that accommodates the electrode assembly 30 and an electrolyte therein, a cap assembly 50 that is connected to an opening of the case 10 and that seals the case 10, and an insulating plate 37 disposed between the electrode assembly 30 and the cap assembly 50 within the case 10.

The electrode assembly 30 may include a separator 32, a first electrode 33, and the second electrode 31. The separator 32 is interposed between the first electrode 33 and the second electrode 31, and the electrode assembly 30 may be wound in a jelly-roll form.

The first electrode 33 may include a first base (e.g., a first substrate) and a first active material layer disposed on the first base. A first lead tap 35 may extend from a first uncoated part of the first base at where the first active material layer is not disposed toward the outside. The first lead tap 35 may be electrically connected to the cap assembly 50.

The second electrode 31 may include a second base (e.g., a second substrate) and a second active material layer disposed on the second base. A second lead tap 34 may extend from a second uncoated part of the second base at where the second active material layer is not disposed toward the outside. The second lead tap 34 may be electrically connected to the case 10. The first lead tap 35 and the second lead tap 34 may extend in opposite directions.

The first electrode 33 may act as a positive electrode. In such an embodiment, the first base may include (or may be composed of) aluminum foil, for example. The first active material layer may include a transition metal oxide, for example. The second electrode 31 may act as a negative electrode. In such an embodiment, the second base may include (or may be composed of) copper foil or nickel foil, for example. The second active material layer may include graphite, for example.

The separator 32 permits movement of lithium ions while preventing the short-circuit of the first electrode 33 and the second electrode 31. The separator 32 may include (or may be composed of) a polyethylene film, a polypropylene film, or a polyethylene-polypropylene film, for example. The case 10 may accommodate the electrode assembly 30 and an electrolyte and forms an external form (or external appearance) of the battery along with the cap assembly 50. The case 10 may include a body part 12 having an approximate cylindrical shape and a bottom part 11 connected to (e.g., extending from) one side of the body part 12. A beading part (e.g., a bead) 13 that is deformed toward the inside of the body part 12 may be disposed in (or formed in) the body part 12. A crimping part (e.g., a crimp or crimped end) 15 that has been bent toward the inside of (or the center of) the body part 12 may be disposed at an end of the body part 12 at the open side.

The beading part 13 may suppress (e.g., restrict or prevent) movement of the electrode assembly 30 within the case 10 and may facilitate settlement of a gasket 14 and the cap assembly 50. The crimping part 15 may firmly fix the cap assembly 50 by pressurizing an edge of the cap assembly 50 via the gasket 14. The case 10 may be made of iron plated with nickel, for example.

The cap assembly 50 may seal the case 10 by being fixed to the inside of the crimping part 15 through the gasket 14. The cap assembly 50 may include a cap-up part, a safety vent, a cap-down part, an insulating member, and a sub-plate, but the present disclosure is not limited thereto. The cap assembly 50 may be variously deformed.

The cap-up part may be disposed at the top of the cap assembly 50. The cap-up part may include a terminal part that protrudes upward convexly and to be connected to an external circuit. An output for discharging gas may be disposed in the cap-up part around the terminal part.

The safety vent may be disposed under the cap-up part. The safety vent may include a protruding part that protrudes downward convexly and is connected to the sub-plate and at least one notch disposed around the protruding part.

When gas is generated due to over-charging or abnormal operation of the secondary battery, the protruding part may be upward deformed by the gas pressure and may separate from the sub-plate. Furthermore, the safety vent may be cut (e.g., may tear or burst) along the notch. The cut safety vent can prevent explosion of the secondary battery by discharging the gas to the outside.

The cap-down part may be disposed under the safety vent. A first opening for exposing the protruding part of the safety vent and a second opening for discharging a gas may be disposed in (or formed in) the cap-down part. The insulating member may be disposed between the safety vent and the cap-down part and may insulate the safety vent and the cap-down part.

The sub-plate may be disposed under the cap-down part. The sub-plate may be fixed to the bottom of the cap-down part to close (e.g., seal) the first opening of the cap-down part. The protruding part of the safety vent may be fixed to the sub-plate. The first lead tap 35 that extends from the electrode assembly 30 may be fixed to the sub-plate. Accordingly, the cap-up part, the safety vent, the cap-down part, and the sub-plate may be electrically connected to the first electrode 33 of the electrode assembly 30.

The insulating plate 37 may be disposed to adjoin (e.g., may be disposed on) the electrode assembly 30 under the beading part 13. A tap opening for withdrawing the first lead tap 35 may be provided in the insulating plate 37. The cap assembly 50 that has been electrically connected to the first electrode 33 by the first lead tap 35 may face the electrode assembly 30 with the insulating plate 37 interposed therebetween. The cap assembly 50 may maintain the state in which the cap assembly 50 has been insulated from the electrode assembly 30 by the insulating plate 37. The cylindrical secondary battery may include another insulating plate 36 for insulation between the electrode assembly 30 and the bottom part 11 of the case 10.

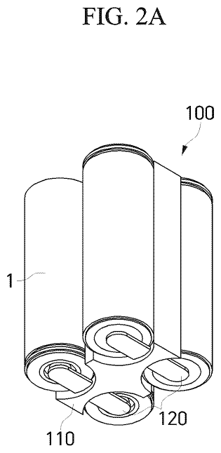

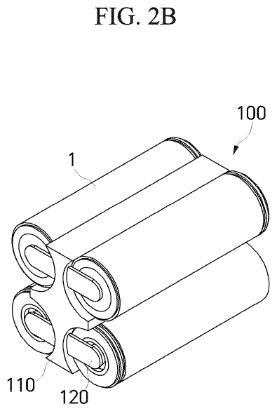

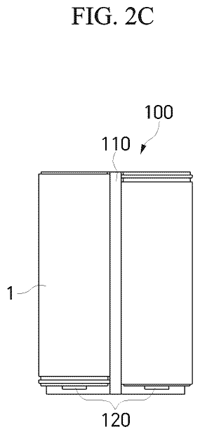

FIGS. 2A to 2C are diagrams illustrating a battery pack that is constructed by mounting a battery cell mounting apparatus, according to embodiments of the present disclosure, on a battery cell.

FIGS. 2A to 2C illustrate a battery cell mounting apparatus 100, according to embodiments of the present disclosure, in which four battery cells 1 are mounted on a spacer. The battery cell mounting apparatus 100, according to embodiments of the present disclosure, may include a spacer 110 and a plurality of electrode tabs 120.

The spacer 110 may have a shape corresponding to shapes of the sides of the plurality of battery cells 1 and may support the sides of the plurality of battery cells 1. In some embodiments, the battery cell 1 may be a cylindrical secondary battery. Accordingly, the spacer 110 may have a side shape having an arc shape in accordance with (e.g., corresponding to) the side shape of the battery cell 1. The spacer 110 supports the sides of the battery cells 1 and absorbs an impact by being inserted between the battery cells 1. In some embodiments, the spacer 110 may be made of a polymer resin, for example, polyethylene (PE), polypropylene (PP), polyvinyl chloride (PVC), polystyrene (CPS), polyethylene terephthalate (PETE), polycarbonate (PC), or polyacrylonitrile-butadiene-styrene (ABS), which are electrically insulating, light-weight, and heat-resistant as an insulating material. However, the spacer 110 is not limited to the above-listed materials and may include various suitable substances having an electrical insulation property.

In some embodiments, the spacer 110 may be formed to have a length greater than the length of the battery cell 1 and may protrude more than (e.g., may protrude beyond) the battery cell 1 when the battery cell 1 is coupled with the spacer 110. Accordingly, although an impact is applied to the battery cell mounting apparatus 100 when the battery cell mounting apparatus 100 is subsequently coupled with a case of a battery pack, the impact is not directly applied to the battery cell 1, and the spacer 110 can absorb the impact. Furthermore, as described later, to integrate the electrode tab 120 that is welded with the battery cell 1 and the spacer 110, the spacer 110 may have a shape in which the spacer protrudes more than (e.g., protrudes beyond) the battery cell 1 so that the electrode tab 120 can be easily inserted into the spacer 110.

The plurality of electrode tabs 120 may each include an electrical connection member for electrically connecting the plurality of battery cells 1. The plurality of electrode tabs 120 may be electrically connected to the plurality of battery cells 1 to connect the plurality of battery cells 1 in series or in parallel. The electrode tab 120 may be a metal material having excellent conductivity. The electrode tab 120 may be made of at least one material that is selected from among nickel, aluminum, copper, or silver materials, for example. However, the electrode tab 120, according to embodiments of the present disclosure, is not limited to the above materials and may include various substances having a conductivity property.

One or more of the plurality of electrode tabs 120 may be inserted into the spacer 110 and formed integrally therewith. In some embodiments, the spacer 110 may be formed by insert-injection the electrode tab 120 to be inserted into the spacer 110. Insert-injection may refer to an injection process method of injecting and processing a raw material in the state in which an insert (e.g., an external element or an accessory) is present within a mold to improve the strength, functionality, and external appearance of a part.

According to embodiments of the present disclosure, in constructing a battery pack that is constructed by connecting a plurality of battery cells in series or in parallel, costs can be reduced because materials are standardized and a process is simplified through a standardized structure.

According to embodiments of the present disclosure, coupling strength when a battery cell is mounted on the spacer can be increased because a coupling force between the spacer and the electrode tab is increased by integrating the spacer and the electrode tab.

According to embodiments of the present disclosure, the volume of a battery pack can be reduced because an integrated portion of the spacer and the electrode tab is optimized.

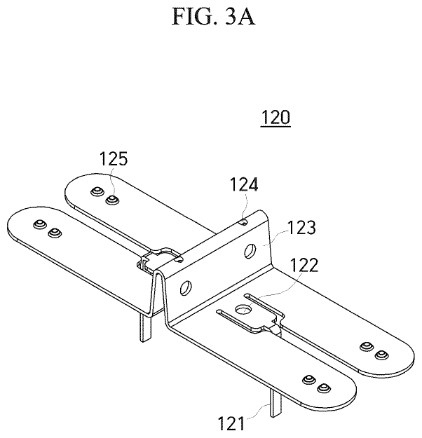

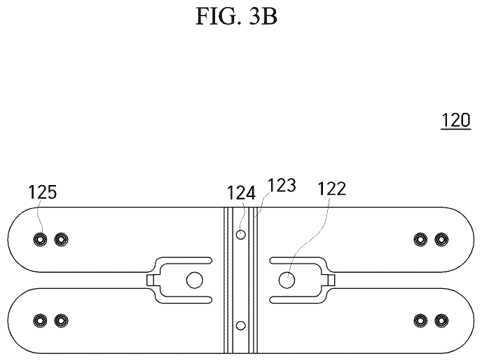

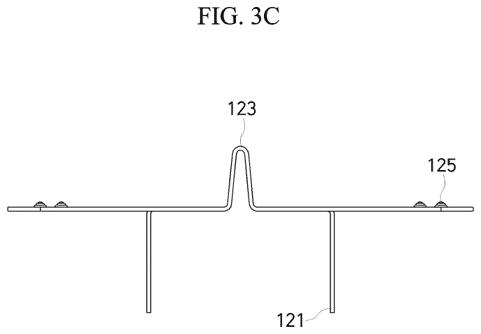

The location of the electrode tab 120 may need to be fixed with respect to the battery cell mounting apparatus 100, according to embodiments of the present disclosure, because injection needs to be performed after the electrode tab 120 is fixed at an accurate location of an injection mold to inject the spacer 110 by inserting the electrode tab 120. This is described below with reference to FIGS. 3A to 3C.

FIGS. 3A to 3C illustrate an electrode tab of the battery cell mounting apparatus according to embodiments of the present disclosure.

Referring to FIGS. 3A to 3C, the electrode tab 120 of the battery cell mounting apparatus 100, according to embodiments of the present disclosure, may include fixing legs 121 that downward extend to fix the electrode tab 120. As illustrated in FIGS. 3A to 3C, the fixing leg 121 may be formed by cutting a part of the electrode tab 120 and bending the part downwardly. The fixing leg 121 may enable the electrode tab 120 to be fixed without moving in a Z axis direction through clamping before the spacer 110 is injected. Accordingly, the spacer 110 can be injected into the electrode tab 120 in the state in which the location of the electrode tab 120 has been fixed. The fixing leg 121 may be removed through trimming after the spacer 110 is injected.

In some embodiments, the electrode tab 120 may include one or more fixing holes (e.g., fixing openings) 122 for fixing the electrode tab 120 when the spacer 110 is injected. The fixing hole 122 may allow a fixing pin to pass through the fixing hole when the spacer 110 is injected so that the electrode tab 120 is fixed without moving or rotating in X and Y axis directions. Accordingly, the spacer 110 can be injected in the state in which the location of the electrode tab 120 has been fixed.

In some embodiments, the electrode tab 120 may include a protrusion 123 that is inserted into the spacer 110 and that protrudes a direction toward the inside of the spacer 110. The protrusion 123 may be disposed inside the spacer 110 after the spacer 110 is injected and may help prevent the electrode tab 120 from stepping (or moving) aside.

In some embodiments, the protrusion 123 may include one or more through holes (e.g., openings) 124. The through hole 124 may be formed at the top or side of the protrusion 123. When the spacer 110 is injected, an injection product flows into the through hole 124 and is hardened therein so that a fastening force between the electrode tab 120 and the spacer 110 is improved.

A welding hole (e.g., a welding opening) 125 may be formed at the end of the electrode tab 120 for welding with the battery cell 1.

According to embodiments of the present disclosure, the spacer is integrally formed with the electrode tab by insert-injection in the state in which the electrode tab has been fixed. Accordingly, the electrode tab can be disposed at a fixed location with respect to the spacer, and an accurate location of the electrode tab can be secured when the battery cell is mounted on the spacer.

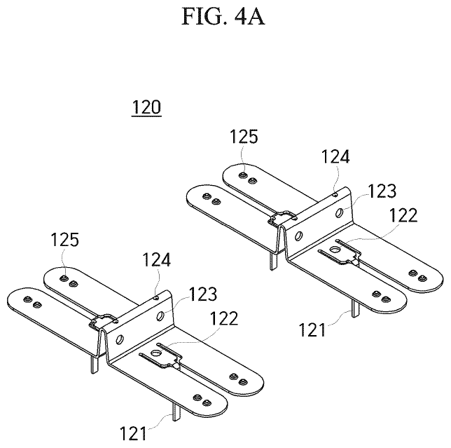

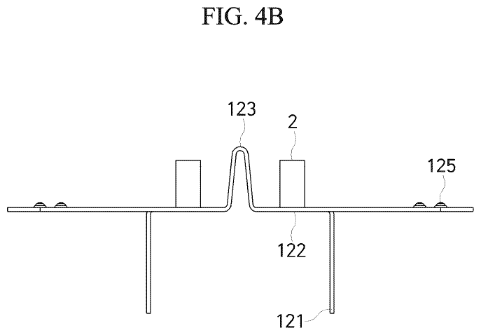

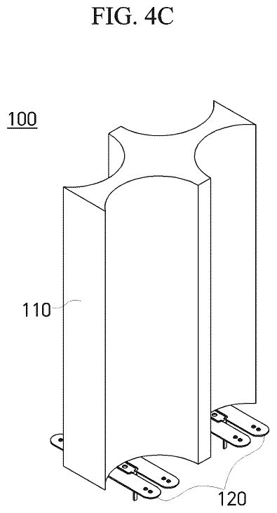

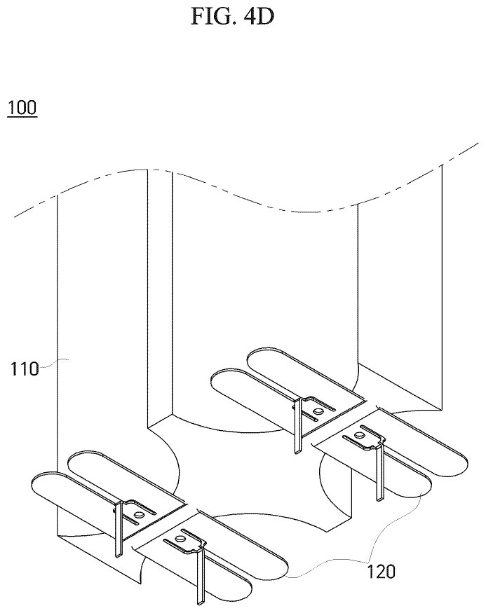

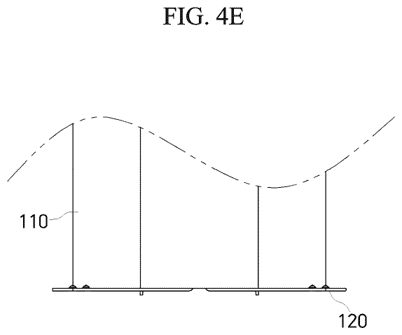

FIGS. 4A to 4E illustrate steps of a method of manufacturing the battery cell mounting apparatus according to embodiments of the present disclosure.

FIGS. 4A to 4E illustrate steps of a process of inserting two electrode tabs 120 at the bottom of the spacer 110 so that the battery cell mounting apparatus 100 is integrally formed to fix four battery cells.

Referring to FIG. 4A, the electrode tab 120 may be seated in an injection mold.

Referring to FIG. 4B, the fixing leg 121 of the electrode tab 120 may be fixed through clamping so that the electrode tab 120 is not moved in the Z axis direction. A fixing pin 2 may pass through the fixing hole 122 so that the electrode tab 120 is not moved or rotated in the X and Y axis directions.

Referring to FIG. 4C, the battery cell mounting apparatus 100 is integrally formed by injecting the spacer 110 in the state in which the electrode tab 120 has been fixed.

Referring to FIG. 4D, after the battery cell mounting apparatus 100 is integrally formed, the fixing leg 121 remains. The fixing leg 121 may be removed through trimming as illustrated in FIG. 4E.

As described above, in the battery cell mounting apparatus 100 according to embodiments of the present disclosure, one or more of the plurality of electrode tabs 120 may be inserted into the spacer 110 and formed integrally therewith. FIGS. 2A to 4D illustrate embodiments in which the number of battery cells 1 attached to the spacer 110 is four. However, the number of battery cells 1 or a method of connecting the battery cells may be varied depending on an apparatus to which the battery cells are applied. Although the number of battery cells 1 or the method of connecting the battery cells is varied, the battery cell mounting apparatus 100 according to embodiments of the present disclosure may be applied without any change or without a change in the technical spirit of the present disclosure.

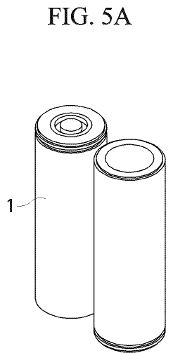

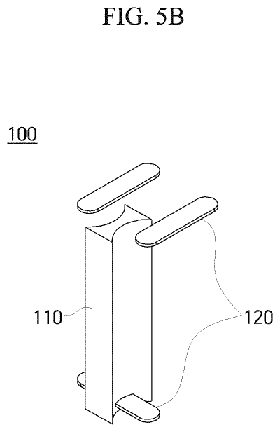

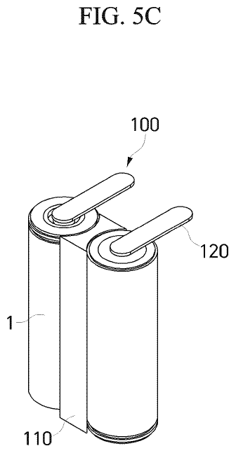

FIGS. 5A to 5C illustrate a battery cell mounting apparatus according to embodiments of the present disclosure in which battery cells are connected in a 2s1p (2 serial 1 parallel) configuration.

FIGS. 5A to 5C illustrate an embodiment in which the battery cell mounting apparatus, according to embodiments of the present disclosure, is connected to two battery cells in a 2s1p configuration. In such an embodiment, one electrode tab 120 having a straight shape at the bottom of the battery cell mounting apparatus 100 may be formed integrally with the spacer 110, and two electrode tabs 120, each having a straight shape at the top of the battery cell mounting apparatus 100, may be coupled to the battery cell 1 by welding in the state in which the two electrode tabs 120 have been separated from the spacer 110.

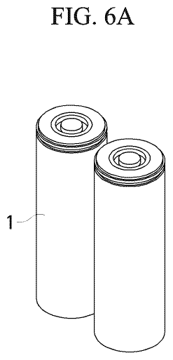

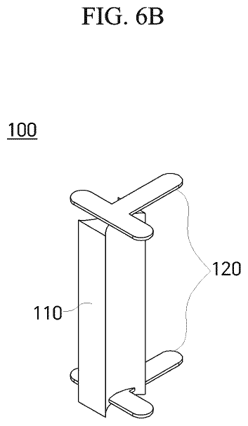

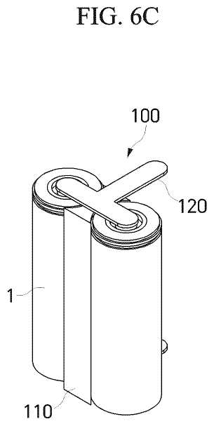

FIGS. 6A to 6C illustrate a battery cell mounting apparatus according to embodiments of the present disclosure in which battery cells are connected in a 1s2p (1 serial 2 parallel) configuration.

FIGS. 6A to 6C illustrate an embodiment in which the battery cell mounting apparatus according to embodiments of the present disclosure is connected to two battery cells in a 1s2p configuration. In such an embodiment, one electrode tab 120 having a T shape at the bottom of the battery cell mounting apparatus 100 may be formed integrally with the spacer 110, and one electrode tab 120 having a T shape at the top of the battery cell mounting apparatus 100 may be coupled to the battery cell 1 by welding in the state in which the one electrode tab 120 has been separated from the spacer 110.

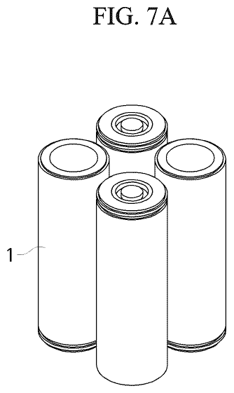

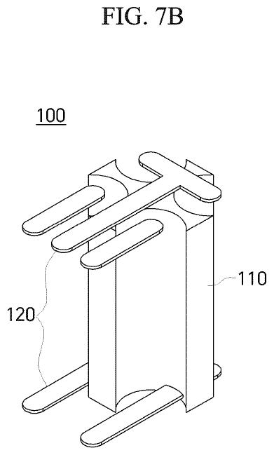

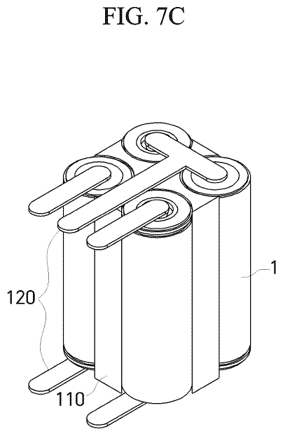

FIGS. 7A to 7C illustrate a battery cell mounting apparatus according to embodiments of the present disclosure in which battery cells are connected in a 4s1p (4 serial 1 parallel) configuration.

FIGS. 7A to 7C illustrate an embodiment in which the battery cell mounting apparatus according to embodiments of the present disclosure is connected to four battery cells in a 4s1p configuration. In such an embodiment, two electrode tabs 120, each having a straight shape at the bottom of the battery cell mounting apparatus 100, may be formed integrally with the spacer 110, and two electrode tabs 120, each having a straight shape, and one electrode tab 120 having a T shape at the top of the battery cell mounting apparatus 100 may be coupled to the battery cell 1 by welding in the state in which the three electrode tabs have been separated from the spacer 110.

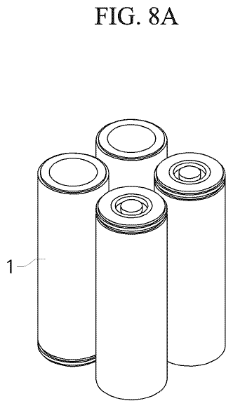

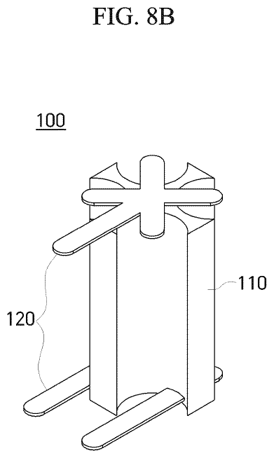

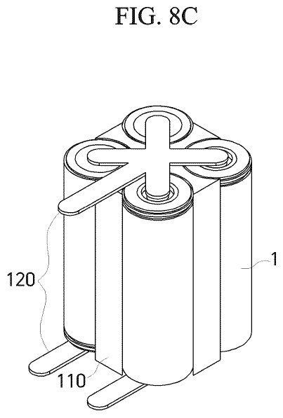

FIGS. 8A to 8C illustrate a battery cell mounting apparatus according to embodiments of the present disclosure in which battery cells are connected in a 2s2p (2 serial 2 parallel) configuration.

FIGS. 8A to 8C illustrate an embodiment n which the battery cell mounting apparatus according to embodiments of the present disclosure is connected to four battery cells in a 2s2p configuration. In such an embodiment, two electrode tabs 120, each having a straight shape at the bottom of the battery cell mounting apparatus 100 according to embodiments of the present disclosure, may be formed integrally with the spacer 110, and one electrode tab 120 having an X shape at the top of the battery cell mounting apparatus 100 may be coupled to the battery cell 1 by welding in the state in which the one electrode tab 120 has been separated from the spacer 110.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}XcO₂₋ₐDₐ (0.90≤a≤1.8, 0≤b≤0.5, 0≤c≤0.5, 0<α<2); LiₐNi_{1-b-c}Mn_{b}X_{c}O_{2-α}Dα (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

Although the present disclosure has been described above in connection with some embodiments thereof, the present disclosure is not limited to the described embodiments. A person having ordinary knowledge in the art to which the present disclosure pertains may modify and change the present disclosure within the technical spirit of the present disclosure and the equivalent range of the following claims.

DESCRIPTION OF SOME REFERENCE SYMBOLS

| | |
|---|---|
| 100: battery cell mounting apparatus | 110: spacer |
| 120: electrode tab | 121: fixing leg |
| 122: fixing hole | 123: protrusion |
| 124: through hole | 125: welding hole |

What is claimed is:

1. A battery cell mounting apparatus comprising:
a spacer having a shape corresponding to shapes of sides of a plurality of battery cells and configured to support the sides of the plurality of battery cells; and
a plurality of electrode tabs configured to electrically connect the plurality of battery cells,
wherein one of the electrode tabs is inserted into the spacer and formed integrally with the spacer.

2. The battery cell mounting apparatus as claimed in claim 1, wherein the spacer is formed by insert-injecting the electrode tab to be inserted into the spacer.

3. The battery cell mounting apparatus as claimed in claim 2, wherein the electrode tab comprises fixing legs that downwardly extend to fix the electrode tab when the spacer is injected.

4. The battery cell mounting apparatus as claimed in claim 2, wherein the electrode tab has a fixing opening for fixing the electrode tab when the spacer is injected.

5. The battery cell mounting apparatus as claimed in claim 1, wherein the electrode tab comprises a protrusion inserted into the spacer and protruding in a direction toward an inside of the spacer.

6. The battery cell mounting apparatus as claimed in claim 5, wherein the protrusion has a through hole.

7. The battery cell mounting apparatus as claimed in claim 1, wherein a welding opening for welding with the battery cell is at an end of the electrode tab.

8. The battery cell mounting apparatus as claimed in claim 1, wherein the spacer has a length longer than a length of the battery cell so that the spacer protrudes beyond the battery cell when the battery cell is coupled to the spacer.

9. A battery pack comprising:
a plurality of battery cells;
a spacer having a shape corresponding to shapes of sides of a plurality of battery cells that are mounted on the spacer and configured to support the sides of the plurality of battery cells; and
a plurality of electrode tabs configured to electrically connect the plurality of battery cells,
wherein one of the electrode tabs is inserted into the spacer and formed integrally with the spacer.

10. The battery pack as claimed in claim 9, wherein the spacer is formed by insert-injecting the electrode tab to be inserted into the spacer.

11. The battery pack as claimed in claim 10, wherein the electrode tab comprises fixing legs that downwardly extend to fix the electrode tab when the spacer is injected.

12. The battery pack as claimed in claim 10, wherein the electrode tab has a fixing opening for fixing the electrode tab when the spacer is injected.

13. The battery pack as claimed in claim 9, wherein the electrode tab comprises a protrusion that is inserted into the spacer and that protrudes in a direction toward an inside of the spacer.

14. The battery pack as claimed in claim 13, wherein the protrusion has a through hole.

15. The battery pack as claimed in claim 9, wherein a welding opening for welding with the battery cell is at an end of the electrode tab.

16. The battery pack as claimed in claim 9, wherein the spacer has a length longer than a length of the battery cell so that the spacer protrudes beyond the battery cell when the battery cell is coupled to the spacer.

17. A method of manufacturing a battery cell mounting apparatus, comprising:
manufacturing a plurality of electrode tabs for electrically connecting a plurality of battery cells; and
integrally forming a spacer having a shape corresponding to shapes of sides of the battery cells and supporting the sides of the battery cells by inserting one or more of the plurality of electrode tabs into the spacer.

18. The method as claimed in claim 17, wherein the integrally forming of the spacer comprises forming the spacer by insert-injecting the electrode tab to be inserted into the spacer.

19. The method as claimed in claim 18, wherein the forming of the spacer by insert-injecting the electrode tab comprises:
fixing the electrode tab by using a downwardly extending fixing leg of the electrode tab; and
injecting the spacer into the fixed electrode tab.

20. The method as claimed in claim 19, further comprising removing the fixing leg after the spacer is injected.
